(19) United States
(12) Patent Application Publication
(10) Pub. No.: US 2002/0184403 A1
(43) Pub. Date: Dec. 5, 2002

(54) Methods for near-optimal bandwidth-constrained placement in a wide-area network

(76) Inventors: Michael D. Dahlin, Austin, TX (US); Arunkumar Venkataramani, Austin, TX (US); Phoebe K. Weidmann, Austin, TX (US)

Correspondence Address: ERIC B. MEYERTONS, CONLEY, ROSE & TAYON, P.C., P.O. BOX 398, AUSTIN, TX, 78767-0398, US

(21) Appl. No.: 10/118,465

(22) Filed: Apr. 8, 2002

Related U.S. Application Data
(60) Provisional application No. 60/282,039, filed on Apr. 6, 2001.

(51) Int. Cl. G06F 9/00

(52) U.S. Cl. 709/316

(57) ABSTRACT

Methods, systems and carrier media are disclosed for near optimal bandwidth-constrained placement of data objects at a collection of distributed caches. The methods may determine placement of data objects based on probability of access requests to those objects, size of the objects, available bandwidth, time available to fill the caches, and/or cost of acquiring copies of the objects from an origin server. Additionally, the methods may account for data objects that already exist in one or more of the caches. The methods may be configured to determine a one-time placement and/or a substantially continuous placement of data objects. Additionally, the methods may be configured to account for variations between the data objects, caches and/or origin servers.

### PRIORITY CLAIM

This application claims the benefit of the U.S. Provisional Patent Application serial No. 60/282,039 entitled “A METHOD FOR NEAR-OPTIMAL BANDWIDTH-CONSTRAINED PLACEMENT IN A WIDE-AREA NETWORK,” to Dahlin, et al. and filed Apr. 6, 2001.

### BACKGROUND OF THE INVENTION

1. Field of the Invention

Embodiments presented herein generally relate to distributed networks. More particularly, embodiments relate to methods and systems for placing copies of objects at distributed caches within a distributed network.

2. Description of the Related Art

Cooperative caching is an emerging paradigm in the design for scalable high-performance distributed systems. In traditional caching systems, the primary function of a cache is to act as a fast intermediate storage between a client or a collection of clients and one or more servers. In such schemes, each request may be satisfied by a cache associated with the requesting machine or by a server of the requested object. Moreover, the storage decisions made by one cache may be independent of those made by other caches in the system. A key characteristic of cooperative caching schemes, on the other hand, is that the caches may cooperate in serving one another's requests as well as in storage decisions.

A goal of a placement method may be to place copies of data objects at a collection of distributed caches to minimize expected access times from distributed clients to those objects. A number of scalable request-forwarding directory schemes have been developed to enable large-scale cooperative caching in WANs and commercial content distribution networks of cooperating caches have been deployed by companies such as Akamai and Digital Island.

Traditional caches may be filled when client demand requests miss locally and cause data to be fetched from a remote site, it is believed that hit rates might be significantly improved by pushing objects to caches before clients request them. Distributed cache placement methods may attempts to select which objects should be pushed to which caches in order to optimize performance. A number of researchers have examined space-constrained placement methods—in which available cache storage space places limits on what can be cached where—in local area networks (LANs) and WANs. For example, Korupolu et al. studied the problem of coordinated placement for hierarchical caches with space constraints, i.e. fixed cache sizes. They demonstrated that under the hierarchical model of distances, the space constrained Amortized Placement method is always within a constant factor (about 13.93) of the optimal. In addition, the simplified greedy version of the amortized placement method has also been shown to provide an approximation of the optimal. In another example, Awerbuch, Bartal and Fiat provide a polylog(n)-competitive on-line method under the assumption that the size of each cache in the on-line method is polylog(n) times more than the size in the optimal method. In yet another example, a network of workstations modeled as a single level hierarchy has been studied by Leff, Wolf and Yu. They provide heuristics for a distributed implementation of their solution.

Replacement methods attempt to solve the problem of determining which object(s) are to be evicted when a cache miss occurs. Studies of replacement methods have been done. In the space constrained scenario, replacement methods may also be viewed as placement methods starting with an empty placement. It has been shown that a hierarchical version of the GreedyDual replacement method exhibits good cooperation and performs well in practice.

In general, space-constrained methods may not depend on object-update frequency, and a good space constrained placement may not be improved by on-demand replication because any new replica must displace a previously placed object. Additionally, replicas of data initially present in caches may have no advantage over other objects.

### SUMMARY OF THE INVENTION

Embodiments presented herein disclose methods and systems for determining places in a LAN/WAN cache or content distribution network (CDN) to store copies of data objects. The methods and systems include bandwidth constrained placement methods, which may place copies of objects at a collection of distributed caches to minimize expected access times from distributed clients to those objects. For example, the methods may be useful in a cooperative caching model in which a cache miss at one location may be satisfied by another cache in the system.

In an embodiment, a method of placing data objects in a plurality of distributed caches may include providing information regarding the data objects. The information provided may be used to determine one or more bandwidth-constrained placements of one or more data objects. The data objects in a placement may be provided to the caches according to the placement. For example, the data objects may be provided to the caches in an order established by the placement. One or more of the data objects provided to the caches may replace a data object that already exists on one of the caches.

In an embodiment, a method of determining at least one placement of at least one data object within a distributed network may include providing information regarding a plurality of data objects accessible via the distributed network. The distributed network may include a plurality of cooperating caches memories. The method may also include determining a benefit of placing a data object within a cache memory. The determined benefit may be used in determining a placement of data objects within the plurality of cooperating cache memories.

For example, in an embodiment, the method may include determining the benefit of placing a data object in at least two different caches. The determined benefits may be used to determine a primary copy of the data object and one or more secondary copies of the data object. The primary and/or secondary copies of the data object may be compared to one or more missing data objects to determine if one or more missing data objects should replace the primary and/or secondary copies in the placement. For example, if the value of one or more missing data objects is greater than the benefit of a primary copy, the primary copy may be replaced in the placement by the missing data object. Similarly, if the value of one or more missing data objects is greater than the benefit of a secondary copy, the secondary copy may be replaced in the placement by the missing data object. In some embodiments, the benefit of a secondary copy may be adjusted to enable more missing data objects to be placed. For example, a total of the values of the missing data objects may be subtracted from the benefit of a secondary copy before comparing the benefit of the secondary copy to the value of a missing data object. In some embodiments, the benefit of a primary copy may also be adjusted. For example, the benefit of a primary copy may be adjusted to account for the probability of a request to access the data object corresponding to the primary copy anywhere on the hierarchy of distributed caches.

In an embodiment, a method of determining at least one placement of at least one data object within a distributed network may be continuous, semi-continuous or iterative. For example, a fill time may be provided in which data objects may be placed in the caches. The method may prioritize data objects to be placed in the caches in a manner that reduces access costs. The method may place a first set of data objects based on a relatively short fill time. Thus, the highest benefit objects may be placed first. The method may then increase the fill time and place a second set of data objects. The placing of data objects and increasing the fill time may continue until some predefined event occurs.

In an embodiment, a method of determining at least one placement of at least one data object within a distributed network may account for data objects already present in caches on the network. For example, the method may set characteristics of the data objects on the caches such that the data objects are ensured to be in the determined placement. To inhibit resending copies of the pre-existing data objects to the caches, the data objects may be removed from the placement before requesting that copies of the data objects in the placement be provided to the caches.

In an embodiment, a method of determining at least one placement of at least one data object within a distributed network may account for the benefit to size ratio of data objects in determining a placement. For example, the method may determine a placement based on a benefit density of data objects to be placed. Similarly, a value density may be used to determine if a missing data object should replace a data object in the placement.

Other embodiments may include methods accounting for both bandwidth and storage size of one or more cooperating caches. Some embodiments may also account for differences in network topologies, and/or origin server or cache server differences (e.g., separation distances, access speeds, communication rates, types of associated data objects, etc.). Additionally, some embodiments may include methods of selecting and/or changing fill times. Other embodiments may include systems and/or carrier media for implementing the methods described above, and/or data object selected by said methods. Additionally, some embodiments may include combinations of the above described methods, systems and/or carrier media.

### BRIEF DESCRIPTION OF THE DRAWINGS

FIG. 1 depicts a network diagram of a wide area network suitable for implementing various embodiments;

FIG. 2 depicts a flowchart of an embodiment of a method of accessing data objects from a plurality of distributed caches;

FIG. 3 depicts a typical computer system suitable for implementing various embodiments;

FIGS. 4a and 4b depict a hierarchical distance model with a multilevel cluster or cluster tree according to one embodiment;

FIG. 5 depicts a flowchart of an embodiment of a method of determining a bandwidth-constrained placement of data objects at a plurality of distributed caches;

FIG. 6 depicts a flowchart of a method of determining a bandwidth-constrained placement of data objects in a plurality of distributed caches that may be used with the methods of FIGS. 5, 7 and/or 8;

FIG. 7 depicts a flowchart of an embodiment of a method of determining a bandwidth-constrained placement of data objects at a plurality of distributed caches that may be used with the methods of FIGS. 5, 6 and/or 8; and

FIG. 8 depicts a flowchart of an embodiment of a method of determining a bandwidth-constrained placement of data objects at a plurality of distributed caches that may be used with the methods of FIGS. 5, 6 and/or 7.

While the invention is susceptible to various modifications and alternative forms, specific embodiments thereof are shown by way of example in the drawings and will be described in detail herein. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF SEVERAL EMBODIMENTS

Methods and systems related to distributed networks are disclosed in U.S. Pat. Nos. 6,286,084 to Wexler et al., 6,098,096 to Tsirigotis et al., and in pending U.S. patent application Ser. No. 09/103,976 (publication number US 2001/0052015), and Ser. No. 09/823,053 (publication number US 2002/0029282), the entirety of which are hereby incorporated by reference as though fully set forth herein.

Embodiments presented herein address the bandwidth-constrained problem of optimizing distribution of data objects over a number of distributed caches. Embodiments presented herein differ from space-constrained models in at least the following ways. First, bandwidth-constrained cost models, as presented herein, may account for object-update frequency and/or the on-demand replication of objects that naturally occurs as demand-reads are processed. Second, in bandwidth-constrained placement models, as presented herein, replicas of data initially present in caches should generally be left there. Third, after a bandwidth-constrained placement is calculated, it may take considerable time to send objects to their caches. In fact, in an embodiment, bandwidth-constrained placement may be a continuous process. For example, as copies of objects are pushed to caches at some low background bandwidth, new objects may be created and/or existing objects may be updated. Thus, it may be advantageous for a bandwidth-constrained placement method to work well in a dynamically changing environment and to provide good performance at intermediate points in its execution.

The Fixed-t_{fill} method presented herein may generate a final placement that is within a constant factor of the cost of a bandwidth-constrained optimal placement under empty-cache initial conditions. The InitFill method, also presented herein, may also provide a final placement that is within a constant factor of the optimal placement even when considering an initial placement. The DoublingEpoch method, also presented herein, may generate a series of placements that are continuously within a constant factor of the optimal placement at any time. Additionally, it is believed that the VariPlace method, presented herein, may augment any of the other methods to achieve near-optimal placement of variable-sized objects.

Embodiments presented herein may be used with local-area network caches, wide-area network caches and/or content distribution networks (CDNs) (e.g., Akamai, Digital Island, Velocigen, Madgeweb, Cisco, etc.). For example, in such embodiments, software implementing methods disclosed herein may determine a nearly optimal set of data to push to each cache or CDN node. Additionally, embodiments presented herein may be useful in computational clusters, networks of workstations, other large-scale distributed systems, or even on-chip memory hierarchies.

An advantage of embodiments presented herein may be that they may be near optimal in terms of the performance they produce under certain assumptions. An additional advantage may be that bandwidth is treated as a key placement constraint. Treating bandwidth as a key placement constraint may be important because it is believed that bandwidth may be a significant constraint in current and projected CDNs. Additionally, methods treating bandwidth as a key placement constraint may be advantageous in that they may account for the popularity of objects (which may correspond to the value of making a copy) and also the update-frequency of objects (which may correspond to the cost of maintaining a copy).

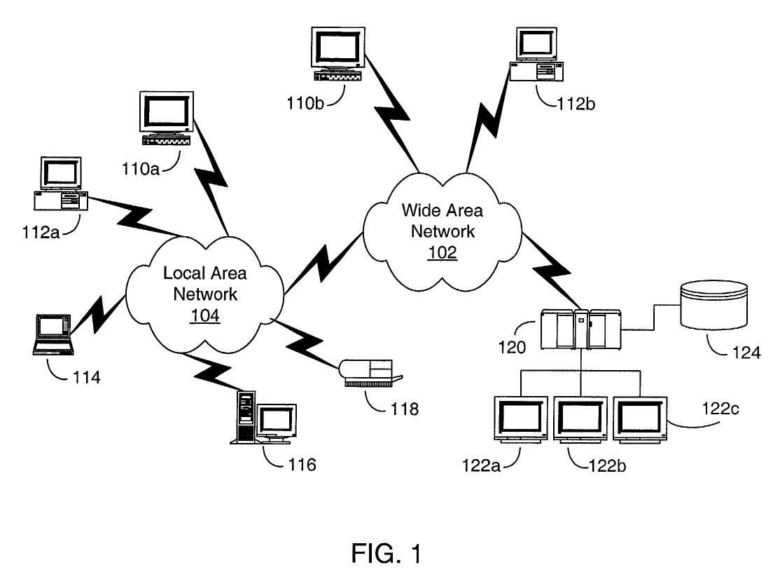

FIG. 1 illustrates a wide area network (WAN) according to one embodiment. A WAN is a network that spans a relatively large geographical area. The Internet is an example of a WAN. WAN 102 may typically include a plurality of computer systems which may be interconnected through one or more networks. Although one particular configuration is shown in FIG. 1, WAN 102 may include a variety of heterogeneous computer systems and networks which are interconnected in a variety of ways and which run a variety of software applications.

One or more local area networks (LANs) 104 may be coupled to WAN 102. A LAN is a network that spans a relatively small area. Typically, a LAN 104 may be confined to a single building or group of buildings. Each device (e.g., individual computer system) on a LAN may have its own CPU with which it executes programs. Each device may be able to access data and other devices anywhere on the LAN. LAN 104 may allow many users to share devices as well as data stored on origin servers and/or caches. As used herein, an “origin server” refers to a device coupled to a LAN or WAN that acts as repository of data objects. An origin server may be configured to provide a data object to devices on the network in response to a request to access the data object. As used herein, a “cache” may refer to a memory coupled to a network. Typically, a cache may be located between an origin server and a device that may request access to a data object. Such a configuration may allow the cache to serve a requested data object to the device thereby reducing the time required to access the data object. A cache may implement memory storage in a manner known in the art, such as in SRAM, DRAM, magnetic media, optical media, etc. As used herein, a “data object” refers to any data stored and/or communicated between devices on a network. Data objects may include, but are not limited to: multimedia files, text files, graphics files, program files, web pages, web content files, streaming media, program instructions, and/or other information. LAN 104 and/or WAN 102 may be characterized by any of a variety of types of topology (e.g., the geometric arrangement of devices on the network, etc.), of protocols (e.g., rules and/or specifications for sending data, whether the network uses a peer-to-peer or client/server architecture, etc.), and of media (e.g., twisted-pair wire, coaxial cables, fiber optic cables, radio waves, etc.).

LAN 104 may include a plurality of interconnected computer systems and optionally one or more other devices. For example, LAN 104 may include but is not limited to: one or more workstations 110a, one or more personal computers 112a, one or more laptop or notebook computer systems 114, one or more server computer systems 116, and/or one or more network printers 118. LAN 104 may be coupled to other computer systems and/or other devices and/or other LANs 104 through WAN 102.

One or more mainframe computer systems 120 may be coupled to WAN 102. As shown, mainframe 120 may be coupled to a storage device or file server 124 and mainframe terminals 122a, 122b, and 122c. Mainframe terminals 122a, 122b, and 122c may access data stored in the storage device or file server 124 coupled to or included in mainframe computer system 120.

WAN 102 may include computer systems which are connected to WAN 102 individually and not through a LAN 104. For example, WAN 102 may include but is not limited to: one or more workstations 110b and/or one or more personal computers 112b. In another example, WAN 102 may include a number of computer systems, which are geographically remote and connected to each other through the Internet.

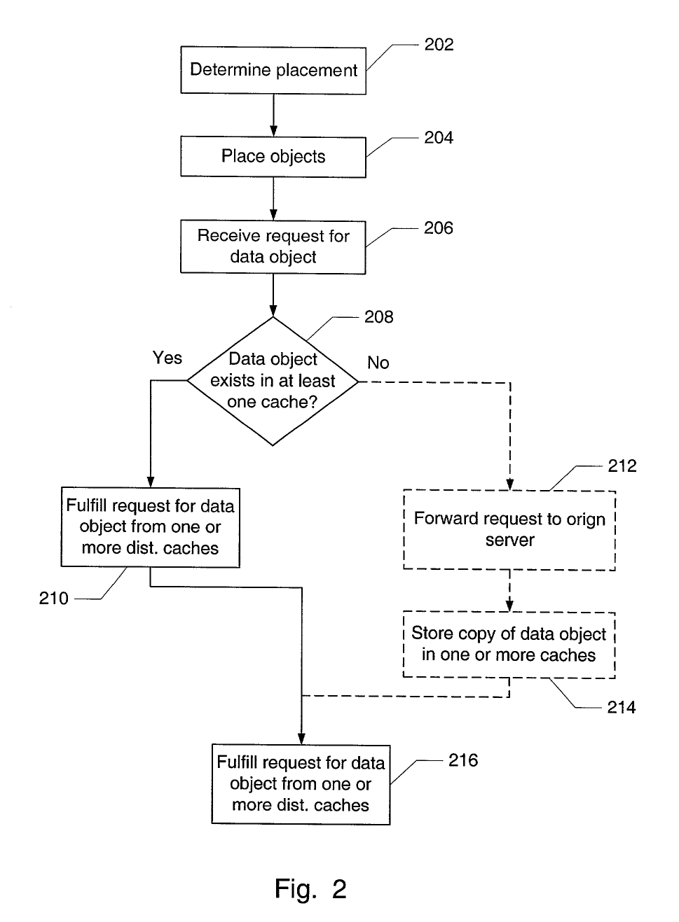

Referring to FIG. 2, a flowchart of an embodiment of a method of utilizing a system of distributed caches is depicted. After a placement of data objects on a plurality of distributed caches has been determined, as depicted in box 202, the data objects may be placed in the caches, as shown in box 204. A request may be received to access at data object at box 206. The access request may be received during determination of the placement, during placing the data objects, or after placing the data objects. At box 208, a determination may be made of whether a copy of the requested data objects exists on at least one of the caches. If a copy of the data object exists on one of the caches, the data object may be sent to the requestor from the cache as shown in box 210. If no copy of the requested data object exists on any of the caches, the access request may optionally be routed to an origin server as shown in box 212. The origin server may send a copy of the requested data object to the requestor. Additionally, a copy of the requested data object may be stored on at least one of the distributed caches, as shown in box 214. Regardless of where the requested data object is served from, information about the access request may be logged in a memory as shown in box 216. Information about access requests may be used to determine probabilities of access requests, which may be used in determining placements of data objects in the future.

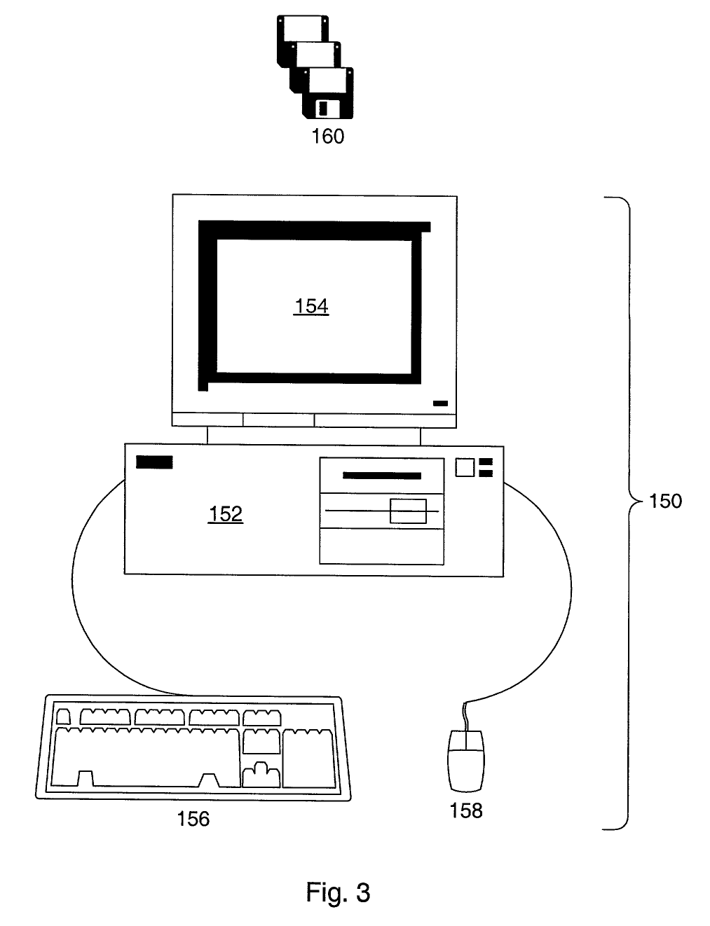

FIG. 3 illustrates a typical computer system 150 which is suitable for implementing various embodiments of methods for placing data objects at a collection of distributed caches. Computer system 150 may typically include a CPU 152 with an associated memory medium (e.g., floppy disks 160). A memory medium may store program instructions for computer programs, wherein the program instructions are executable by the CPU 152. Computer system 150 may further include a display device (e.g., monitor 154), an alphanumeric input device (e.g., a keyboard 156), and a directional input device (e.g., a mouse 158). Computer system 150 may be operable to execute a computer program to implement a method for placing objects at a collection of distributed caches.

Computer system 150 may include a memory medium on which computer programs according to various embodiments may be stored. A memory medium may include, but is not limited to: an installation medium (e.g., a CD-ROM or floppy disk), a system memory (e.g., DRAM, SRAM, EDO RAM, Rambus RAM, etc.), and/or a non-volatile memory (e.g., a magnetic media, such as a hard drive, or an optical storage media). Memory media may include other types of memory as well, or combinations thereof. In addition, a memory medium may be located in a first computer in which programs are executed, or it may be located in a second different computer which connects to the first computer over a network. In the latter instance, the second computer may provide program instructions and/or data to the first computer. Computer system 150 may take various forms, including but not limited to: a personal computer system, a mainframe computer system, a workstation, a network appliance, an Internet appliance, a personal digital assistant (PDA), a television system and/or another device. In general, a computer system may include any device having a processor that may execute instructions from a memory medium.

A memory medium may include a software program or programs for placing objects at a collection of distributed caches, as described herein. Software program(s) may be implemented in various ways, including but not limited to: procedure-based techniques, component-based techniques, and/or object-oriented techniques. For example, software program may be implemented using ActiveX controls, C++ objects, JavaBeans, Microsoft Foundation Classes (MFC), browser-based applications (e.g., Java applets), traditional programs, or other technologies or methodologies, as desired. A CPU may include a means for creating and executing a software program or programs according to the methods and/or diagrams described below.

In an embodiment, a network may include a number of client computer systems in communication with a number of origin servers. Additionally, a number of cache servers and/or routers may be between the origin servers and client systems. Performance of such a network may be considered in terms of the time required to access data on the network. For purposes of the discussion below, the network architecture may be modeled as a set of N distributed cache servers (referred to herein simply as “machines”) and a set of S origin servers connected by a network. The machines may access a set of M data objects maintained at any of the origin servers and/or cached at the machines. As used herein, “N,” “S,” and “M” are variables that may take on any integer value depending on the particular network. Each machine i, may have a fixed available bandwidth denoted by bw(i) to push objects into the cache at machine i. The size of the cache at every machine may be very large.

The cost of communication between any pair of machines i and j may be described by the function dist(i, j). A client at or near machine i may request a data object α. If there exists a local copy of requested data object α at machine i, then data object α may be served locally. That is, the data object may be sent to the requesting client from machine i. As used herein, when a data object is present in a memory, either at a cache server or origin server, then a request for the data object may be said to “hit” the data object at the memory. If there is no copy of requested data object α at machine I (i.e., the request is a “miss”), then a directory or hint cache may be consulted to find a nearby copy of data object α. The copy of data object α may be supplied to the requestor from the nearby copy, preferably from the nearest copy. In such a case, a copy of data object α may also be saved on machine i. Thus, future requests for data object α at machine i may be local hits (i.e., provided to the requestor from machine i) until data object α is modified or until machine i discards data object α. The cost of satisfying an access request for an object α at a machine i, denoted by c(i, α), may be modeled as the cost of communication, dist(i, j), between i and j, where j is the closest machine that possesses a copy of object α. If no copy of object α resides on any of the caches in the network, then c(i, α) may take a value Δ, which denotes the miss penalty. As used herein, the “miss penalty” refers to the cost of obtaining a requested data object directly from an origin server rather than from one of the cooperating caches. An example of a system with properties as described above may include a large-scale content distribution network where bandwidth costs dominate storage costs and where the caches have a fixed available bandwidth to receive new or updated objects into them.

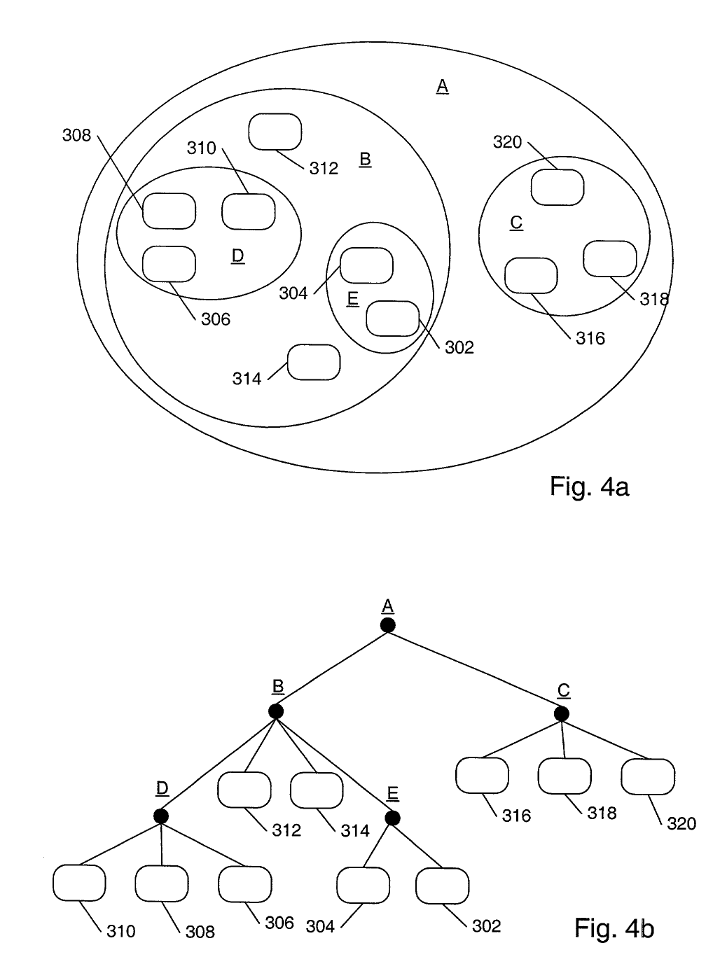

A distributed network as described above may be modeled by a hierarchical model. This hierarchy may be understood as a multilevel cluster or a cluster tree. Referring to FIG. 4a, an embodiment of a distributed network is depicted. As depicted in FIG. 4a, cache servers may be organized in a number of clusters. For example, cache servers 302 and 304 may be considered to reside in cluster E. Likewise, cache servers 306, 308 and 310 may be considered to reside in cluster D. Cluster B may include clusters D and E, as well as cache servers 312 and 314. Cluster A may include clusters B and C (i.e., cache servers 316, 318 and 320). Such an organization of machines reflects the way many wide area network topologies are structured. For example, in a university wide network each machine may belong to a department cluster, which in turn may belong to a college cluster, which in turn may belong to the university cluster. Furthermore, machines organized in an arbitrary network topology may be logically grouped by distance so as to approximate a hierarchy of machines. Thus, the cluster structure of FIG. 4a may be alternately viewed as a hierarchy as depicted in FIG. 4b. In FIG. 4b, each cache server may form a terminus of the hierarchy, and each cluster may reside under a node.

As used herein, a “depth-0 hierarchy” refers to a singleton set containing one machine. For example, cache server 320 may be considered a depth-0 hierarchy. As used herein, a “depth-d hierarchy” refers to a node H plus a set of hierarchies Hₗ, H_{Z}, . . . , Hₖ, each of depth smaller than d, and at least one of which has depth exactly d−1. Thus, node A may be considered a depth-3 hierarchy. In such a model, hierarchies H₁ . . . Hₖ may be referred to as the “children” of H. Similarly, H itself may be referred to as the “parent” of H₁ . . . Hₖ. A hierarchy may be described with a diameter function, diam. Diameter function diam may be defined as follows: If H is a singleton hierarchy, diam(H)=0, else diam(H)>λdiam(Hᵢ), for all children Hᵢ of H, where λ is a constant greater than 1. Such a hierarchy may be said to be λ-separated. For any hierarchy H, machines(i) is refers to be the set of singleton hierarchies that are children of H. The distance function dist(i, j) between any two machines i and j belonging to H is defined as diam(Hₗ) where Hₗ is the least depth hierarchy such that i and j belong to machines (Hᵢ). For example, dist(i, j) between cache server 314 and cache server 302 is equal to the diameter of cluster B.

Thus, in an embodiment, a hierarchy may be viewed as a cluster tree. The two terms are used interchangeably herein. In such an embodiment, the cache servers are at the “leaf nodes” (e.g., terminal ends). Intermediate nodes (e.g., node B of FIG. 4b) are “virtual.” Intermediate nodes serve to maintain book-keeping information. To simplify modeling analysis, the distance function described above may ignore small variations in cost inside a subtree. Thus, each machine may have a set of nearby neighbors at approximately the same distance. For example, each nearby neighbor may be considered to be at distance d₁ from the machine. Extending this concept, the next closest neighbors of a machine may be considered to be at a distance d₂, and so on.

The model described above may be used to capture a wide variety of distributed networks like intranets or WANs. A local area network for example may be a depth-1 hierarchy. The model may also be used to describe content distribution networks. In such a case, the leaf caches may be geographically distributed pseudo-servers. A client request originating at an internet service provider (ISP) may be directed to one of these caches that may either serve the object or redirect the request to a neighboring cache which stores a copy. If none of the caches stores the requested object, then the request may be directed to an origin server for the object. The model may also be used to describe multi-level cache hierarchies where both the leaves and the intermediate nodes store and serve objects. In such a case, intermediate nodes in the multi-level cache hierarchy may be mapped to leaf nodes in a network hierarchy as described above. Such leaf nodes may have as parents root nodes of level-j hierarchies where j>=1. It is believed that the model may also serve as an approximation of a complex network such as the Internet.

As used herein, a “placement” refers to assigning copies of data objects to machines in a hierarchy. As used herein, a “bandwidth-constrained placement” refers to a placement determined in a manner that accounts for one or more bandwidth limitations. As used herein, a “copy” denoted by copy (i, α) refers to a pair consisting of a machine i in the hierarchy and a data object α. A data object may be associated with an expiry time, denoted by expiry (α). The expiry time represents the point of time at which the object will be invalidated. In practice, expiry (α) may be known or estimated a priori. For example, a newspaper website may be updated every night at 1 a.m. In another example, past update patterns may be used to estimate the next update.

As used herein, the probability of receiving a request to access a data object α at any machine i before expiry(α) is denoted as p(i, α), and is referred to herein as the “probability of access”. Similarly, for any hierarchy H, the aggregate probability of receiving a request to access an object α before expiry(α) is denoted as p(H, α). The aggregate probability may be determined by 1−Π_{I}ε_{machines(H)}(1−p(i, α)). That is, aggregate probability refers to the probability receiving a request to access of object α at at least one of the leaf nodes in the tree rooted at H. If there is a request for a data object α in any hierarchy H, none of whose machines has a copy of data object α, the cost of leaving H to fetch a copy of data object α may be determined by p(H, α)*(diam(parent(H))−diam(H)).

The probability of receiving a request to access a data object may be known or estimated using application specific benchmarks with knowledge of history based statistical information. As previously described, data objects may be associated with lifetimes (e.g., expiry times) and probabilities of access. Either or both of these parameters may introduce temporal variation into determination of placements. Therefore, a time constraint, t_{fill}, may be introduced. Time t_{fill} may be the time during which a placement is to be accomplished. The time t_{fill} may also be described as the available fill-time. Thus, given probabilities of access and the available bandwidth to push objects into machines, a bandwidth-constrained placement method may attempt to determine a placement that minimizes access costs, and that may be accomplished within the fill-time.

Several methods for determining bandwidth constrained placement, as defined above, are disclosed herein. Each method description includes a general method flow description followed by a description of an embodiment of a procedure for implementing the described method flow. The methods are described in terms of a centralized implementation. However, a centralized implementation may be transformed into a distributed implementation by configuring each node to process a subset of the data at a level of the hierarchy. The node may then pass the processed information up the hierarchy to the next node for processing at that level. As previously mentioned, nodes on the hierarchy model of FIG. 4 generally do not represent physical machines. Thus, configuring a node to process data may be accomplished by either configuring a computer system (e.g., a server) of that hierarchy to process data for the entire level of the hierarchy. Alternately, processing may be distributed over two or more computer systems (e.g., servers) of that level of the hierarchy. An embodiment of a method that may be suitable to configure a distributed implementation is disclosed by Korupolu et al., in a paper entitled, “Placement Algorithms for Hierarchical Cooperative Caching” which is incorporated by reference as though fully set forth herein.

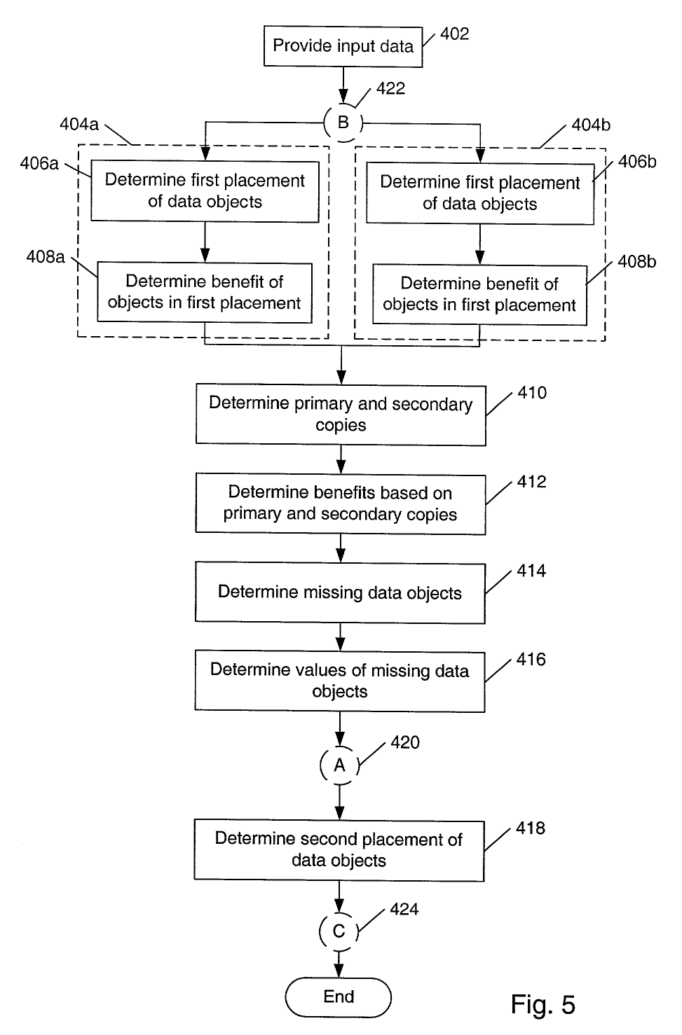

An embodiment of a first method is depicted in FIG. 5. For ease of reference herein, the first method may be referred to as the Fixed-t_{fill} method. For purposes of simplifying the description of the Fixed-t_{fill} method the following discussion generally assumes that: (i) all of the caches are initially empty, (ii) data objects are not modified during t_{fill}, (iii) all requests for access to data objects occur after the placement is complete, (iv) the probabilities of access and the universe of objects are fixed, and (v) all data objects are of equal size. However, the methods described are not limited to such conditions.

The Fixed-t_{fill} method may include a bottom up pass along the cluster tree to determine a first placement. The first placement may be a tentative placement in which each cache determines the locally most valuable set of objects. The method may proceed up the hierarchy by subtrees, having each node improve the corresponding subtree's placement.

Referring to FIG. 5, an embodiment of the Fixed-t_{fill} method flow is depicted in a flowchart. At box 402, input data may be provided. For example, the input data may include, but is not limited to: a description of a network hierarchy, network distances between two or more machines, information regarding a plurality of data objects, a fill-time, available bandwidth for one or more machines. For example, information regarding a plurality of data objects that may be provided may include, but is not limited to: the size of one or more data objects, and access probabilities associated with one or more data objects. In an embodiment, the access probabilities may be specific to each machine.

The input data may be used to determine a first placement for each cooperating cache server, as depicted in box 406a. Such a placement may be referred to as a “local placement.” For example, a local placement may be determined for each of cache servers 404a and 404b (depicted as dashed line boxes). Determining a local placement may include determining data objects with the highest access probabilities for the particular machine. The number of data objects in a local placement may be limited to the number of data objects that may be copied to the cache based on the size of each data object, the available bandwidth of the cache and the fill-time. Thus, a local placement may be determined for cache 404a including 1000 data objects and a local placement may be determined for cache 404b including only 5 data objects. The difference in the number of data objects in the local placements may be due to the size of the data objects and/or the available bandwidth of caches 404a and 404b. In an embodiment, the local placement may be limited to placeable objects. As used herein, a “placeable object” may refer to a data object with a size that may allow the object to be placed in a cache based on the bandwidth of the cache and the available fill-time. In an embodiment, the benefit of a primary copy may be increased by an amount corresponding to the total probability of access by all nodes in a subtree times the network cost of fetching the data object from a node in the next higher subtree.

After a first placement is determined, a benefit of each data object in each placement may be determined, as depicted in box 408a. As used herein, a “benefit” of a data object refers to the increase in total access cost that would be expected if the data object were not placed at the cache. That is, an expected access cost may be determined for a cache based on the first placement and access probabilities of data objects in the first placement and missing data objects. As used herein, a “missing data object” refers to a data object not present in a particular placement. The expected access cost may be re-estimated excluding a selected data object from the placement. The change in the access cost resulting from the removal of the selected data object corresponds to the benefit of the selected data object.

As depicted in box 410, primary and secondary copies of data objects may be determined. As used herein, a “primary copy” refers to a copy of a data object present in at least one placement in a hierarchy (e.g., a local placement, subtree placement, etc.) that is given a high priority to be retained in a final placement. In various embodiments, a primary copy may be determined randomly from a plurality of copies of a data object. In other embodiments, the primary copy may be determined arbitrarily (e.g., the first copy identified, etc.). In still other embodiments, a primary copy may be determined based on the relative benefits of the copies of the data object. For example, the primary copy may be the copy determined to have the highest benefit. The primary and secondary copies may be determined by comparing information from two or more machines (e.g., cache 404a and 404b). For example, a particular data object may be selected to be present in the local placement of both cache 404a and cache 404b. A benefit of the data object in each placement may be determined. The copy of the data object that has the highest benefit may be determined to be the primary copy. As used herein, a “secondary copy” refers to any copy of a data object within a placement for a hierarchy that is not the primary copy.

After the primary and secondary copies are determined, benefits may be determined again based on the primary and secondary copy designations, as depicted in box 412. Specifically, the benefit of a primary copy may be changed from the benefit in a local placement to the overall benefit to the entire hierarchy being considered (in this example, the hierarchy containing caches 404a and 404b).

As depicted in boxes 414 and 416, missing data objects and the value of the missing data objects for the current hierarchy may be determined. As used herein, the “value” of a missing data object refers to the change in total access cost that would be expected if the missing data object were included in the placement.

A second placement may be determined for the set of data objects, as depicted in box 418. The second placement may compare the value of one or more missing data objects to the benefit of data objects present in the current placement. If a missing data object is found to have a value greater than the benefit of a data object present in the current placement, then that data object may be replaced with the missing data object.

The process depicted in FIG. 5 may be repeated at each level of the hierarchy. Thus, during the next iteration boxes 404a and 404b may represent two nodes of the hierarchy. Alternately, one box may represent a node of the hierarchy while the other box represents a cache. In either case, the second placement determined in box 418 may be used as the first placement in box 406 if a placement for a hierarchy rather than a cache is being determined. Likewise, if a placement for a hierarchy was determined at box 406, then benefits may be determined in box 408 as described with regard to box 412.

Following is a procedure for implementing the Fixed-t_{fill} method, as described above. A few definitions are first introduced. For any H, and a placement P over H, an object α is said to be P-missing if no copy of α exists in any of the caches in H. The benefit of an object α at a machine i in a placement P is defined as the increase in the cost of the placement over H were α to be dropped from i and is denoted by benefit(α, i, P). Thus, the benefit of an object is dependent on where other copies of the same object are distributed in the hierarchy. The value of a P-missing object α in a hierarchy H is defined to be p(H, α)−(diam(parent(H))−diam(H)). An implementation of the Fixed-t_{fill} method for bandwidth-constrained placement may be described by:

Input: A hierarchy U, the universe of objects 0, a fill time t fill, available bandwidth bw(i) for iεmachines(U), the access probability p(i, α) for all objects a and iεmachines(U). Let all objects be of size objectsize.

Initialization: For each iεmachines(U), set size(i)=bw(i)−t_{fill}. For each iεmachines(U), select a number of objects └size(i)/objectsize┘ with the highest local probability of access p(i, α) and call this local placement Pi. For each object α that gets selected at machine i, initialize AssignedBenefit(i, α)=p(i, α)·(diam(parent(i))−diam(i)).

Iterative portion: step d, 1<_d<_depth (U)

1. Determine the level-d placement for each depth d hierarchy H as follows: Let H₁ . . . Hₖ be hierarchies that are the immediate children of the hierarchy H. Initialize the placement P_{H} over C to the union of the placements already computed at H₁ . . . Hₖ (e.g. P_{H}=Uᵢε_{children(H)}Pᵢ).

2. Update benefits: For each object α in H that has one or more copies in the current placement P_{H}, let (i, αₚ) designate the primary copy (i.e., the copy with the highest local AssignedBenefit). Adjust the AssignedBenefit of the primary copy by H's aggregate access probability times the cost of leaving hierarchy H (e.g., AssignedBenefit(i, αₚ)+=p(H, α)*(diam(parent(H))−diam(H)). All other copies of α are secondary copies and their AssignedBenefits remain unchanged. Let X denote the set of P_{H}-missing objects.

3. Swap Phase: While there is a P-missing object β in X, whose value is more than the copy(i, α) with the least AssignedBenefit in P, remove the copy(i, α) and substitute a copy of (i, β).

In an embodiment, after a placement over a hierarchy has been determined, the selected copies of objects may be sent into the corresponding machines in an order determined by the placement. For example, the objects may be sent in order of decreasing AssignedBenefits computed at the end of the loop above. Sending the objects in this order may tend to place objects with the highest benefit into the caches first.

Using the Fixed-t_{fill} method, it is feasible that a single secondary copy of some object may prevent swapping in of several missing objects. Though the benefit of the secondary copy may be larger than the value of each of the missing objects, it might be much less than the sum of all these values put together. Therefore, it may be desirable to augment the Fixed-t_{fill} method with an amortization method using a potential function. The potential function may accumulate the values of all the missing objects. The accumulated potential may be used to reduce the benefits of certain secondary copies, thereby accelerating their removal from the placement.

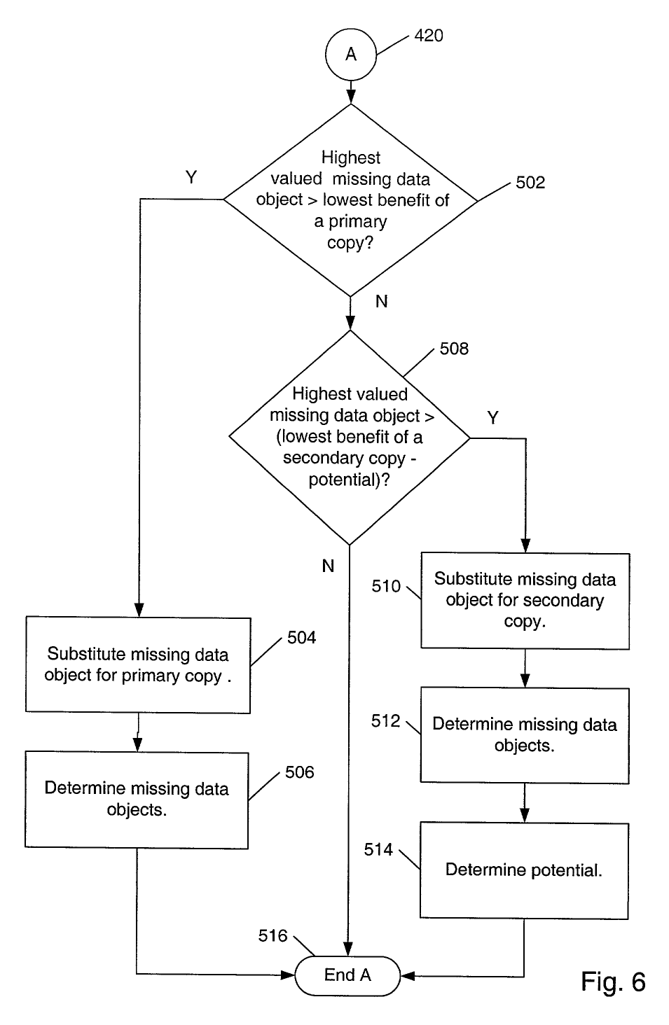

An embodiment of a flowchart of an amortization method suitable for use with the Fixed-t_{fill} method is depicted in FIG. 6. In an embodiment, the amortization method may be incorporated into the Fixed-t_{fill} method at insertion point A, denoted by reference numeral 420 in FIG. 5.

As depicted in box 502, the method may compare the value of the highest valued missing data object with the benefit of the primary copy having the lowest benefit. If the value of the missing data object is larger that the benefit of the primary copy, then the missing data object may be substituted for the primary copy. Since the primary copy was removed from the placement, it may become part of the missing set of data objects with a value equal to its previously determined benefit, as depicted in box 506. If the value of the missing data object is not larger that the benefit of the primary copy, then the value of the missing data object may be compared to an adjusted benefit of a secondary copy, as depicted in box 508. Specifically, the value of the missing data object may be compared to an adjusted benefit of the secondary copy with the lowest benefit in the placement. The benefit of the secondary copy may be adjusted by subtracting the potential of the missing data objects from the benefit of the secondary copy. As used herein, “potential” refers to the sum of the values of the missing data objects. If the value of the missing data object is not larger that the adjusted benefit of the secondary copy, then the method may end. If the value of the missing data object is larger that the adjusted benefit of the secondary copy, then the missing object may be substituted for the secondary copy, as depicted in box 510. The secondary copy is not added to the set of missing data objects, since a primary copy of the data object still exists in the placement; however, since the missing data object with the highest value was added to the placement, it is no longer a missing data object. Thus, the set of missing data objects may be determined, as depicted in box 512. Additionally, the potential may be set to the maximum of zero, or the formerly determined potential minus the value associated with the secondary copy. In an embodiment, at terminus 516, the amortization method may end. For example, a method as depicted in FIG. 5, 7 or 8 may continue from insertion point 420. In an alternate embodiment, the amortization method may iterate. In such an embodiment, the amortization method may cycle through a predetermined number of iterations, or until a predetermined endpoint is reached. For example, the amortization method may iterate until no missing data objects are substituted for copies in the placement.

An implementation of an amortized Fixed-t_{fill} method for bandwidth-constrained placement may be described by:

Initialization: Same as for the Fixed-t_{fill} method except that a potential φᵢ for each machine i is set to zero.

Iterative portion: Same as for the Fixed-t_{fill} method except that the potential φ_{H} is set to the sum of the potentials φ₁ . . . φ₂ computed by the children of H.

1. Determine the level-d placements: Same as for the Fixed-t_{fill} method.

2. Update Benefits: Same as for the Fixed-t_{fill} method.

3. Swap Phase: Same as for the Fixed-t_{fill} method except that the potential φ is used to reduce the AssignedBenefits of some copies.

(i): Let yₚ be the primary copy with the least AssignedBenefit and yₛ be the secondary copy with the least AssignedBenefit in P_{H}. Let X be the set of all P_{H}-missing objects. Let α be the highest-valued object in X.

(ii): If value(α)>min(AssignedBenefit(yₚ), AssignedBenefit(yₛ)−φ_{H}), then perform one of the two following swap operations, and goto step 2.

If AssignedBenefit(yₚ)<AssignedBenefit(yₛ)−φ_{H} swap yₚ with α. Set X to X−α+α′, where α′ is the object corresponding to the copy yₚ. Set value(α′) to benefit(yₚ).

Otherwise, remove yₛ from the placement and substitute it with α. Set X to X−α and reset the potential φ_{H} to max(0, φ_{H}-benefit (yₛ)).

3. Update Potential: Add the values of all the P_{H}-missing objects in X to φ.

In a distributed network, it may be necessary to handle object updates dynamically. New copies of objects may be continuously pushed out to the caches to maintain consistency. Similarly, the universe of available objects may change with time. A stepwise refinement of the Fixed-t_{fill} method, herein after referred to as the InitFill method, may be used to address such conditions. The InitFill method may determine a placement given an existing non-empty set of objects already placed at the machines. For example, consider a content distribution network where a subset of objects has been placed at the caches or content servers over the course of an hour. At this point, a significant number of objects may change, along with their associated probabilities of access. For example, a sudden important news event may cause new articles with higher access probabilities to be posted at a news website. Since not all of the objects might have changed, it may be desirable to leverage the benefit of the objects already placed in the network.

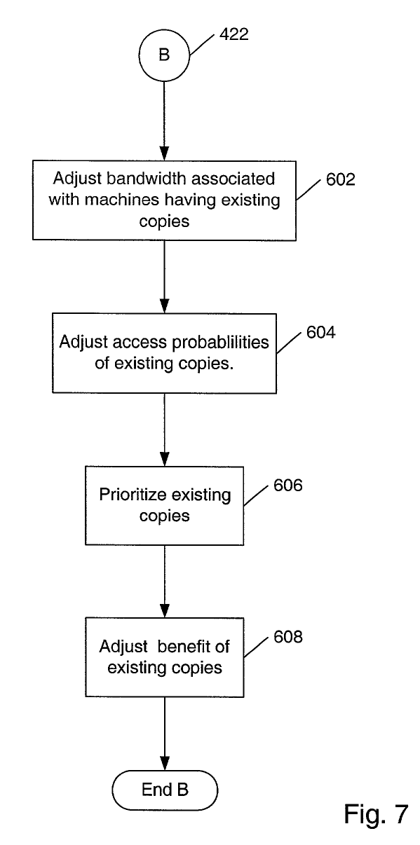

FIG. 7 depicts a flowchart of an embodiment of method of adjusting the Fixed-t_{fill} method to better account for one or more nonempty caches. To address determining a placement in a nonempty cache the Fixed-t_{fill} or amortized Fixed-t_{fill} method may be modified by the InitFill method of FIG. 7. For example, the InitFill method may be inserted into the Fixed-t_{fill} or amortized Fixed-t_{fill} method at insertion point B, denoted by reference numeral 422 in FIG. 5.

As depicted in box 602, the InitFill method may include adjusting the bandwidth associated with machines that have copies of data objects present. Specifically, sufficient “virtual” bandwidth may be added to each machine to account for the existing copies. Since the Fixed-t_{fill} method uses bandwidth multiplied by fill-time to determine which data objects may be placed (i.e., it is bandwidth-constrained), virtual bandwidth may be added to the bandwidth of each machine with existing copies to ensure that the method allows the existing copies to be considered for placement without inhibiting other copies from being added as well. The access probabilities of existing copies of data objects may be adjusted to ensure that the existing copies are present in the first placement, in box 604. Specifically, the access probabilities of existing copies may be set to 1. Similarly, existing copies may be prioritized above other copies in a placement in box 606. For example, existing copies may be designated as primary copies. In an embodiment, the Fixed-t_{fill} method may be modified to ensure that this designation is not changed. At box 608, the benefit of each existing copy may be adjusted. For example, the benefit of existing copies may be set to an effectively infinite value (e.g., an extremely high value). In an embodiment, the Fixed-t_{fill} method may be modified to ensure that this designation is not changed. The InitFill method may then allow the Fixed-t_{fill} or amortized Fixed-t_{fill} method to resume at insertion point B. If the placement determined by the Fixed-t_{fill} or amortized Fixed-t_{fill} method is to be used to populate a plurality of distributed caches, the existing copies may be removed from the placement before requesting copies of the placed data objects.

An implementation of InitFill method for bandwidth-constrained placement given an initial placement P₁ may be described by:

1. Initialization: For each machine i, set size(i) to the sum of the combined size of the objects already present in the cache and bw(i)·t_{fill}. For each copy (i, α) already present in the caches, set p(i, α)=1. Prioritize the already present objects so that in case of a tie while placing the first └size(i)/objectsize┘ objects at machine i, the already placed objects are always placed first. For each of the already placed copies (i, α), set AssignedBenefit(i, α) to ∞.

2. Run the rest of the Fixed-t_{fill} as before, resulting in a final placement, P.

3. Delete from P, all copies (i, α)εPᵢ, so that the already placed objects are not sent to their corresponding caches again.

The InitFill method may allow for an incremental implementation of the Fixed-t_{fill} method. For example, in the case of a plurality of cooperating caches where each machine is initially empty, the Fixed-t_{fill} or amortized Fixed-t_{fill} method may be used to place an initial set of data objects. Thereafter, InitFill method may be invoked to continue and/or supplement the initial placement.

In each of the methods discussed above, a fill-time may be selected a priori. In various embodiments, a plurality of heuristics may be used to select a fill-time. In particular fill-time may be chosen (1) as a fixed amount of time (e.g., 1 hour, 1 minute), (2) proportional to the average lifetime of stored data objects, (3) proportional to the average lifetime of web data objects, and/or (4) dynamically based on the hit rate or update rate. However, in some instances, it may be difficult to choose an optimal fill-time. Therefore, it may be desirable to provide a method that does not require an assumption of fill-time a priori. The Doubling Epoch method presented herein varies the fill-time in a manner that promotes a near-optimal overall placement at the end of any interval.

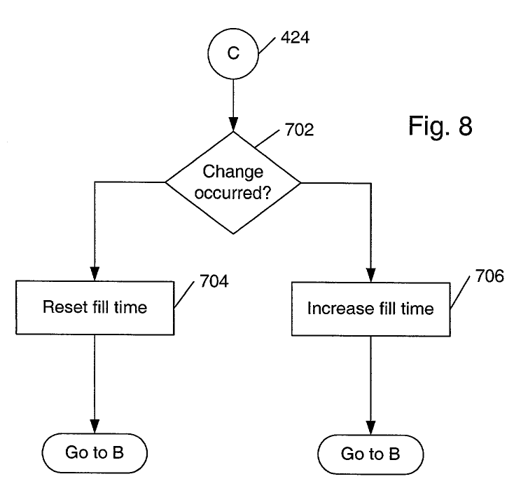

FIG. 8 depicts an exemplary embodiment of the Doubling Epoch method that may be used with a Fixed-t_{fill} method or amortized Fixed-t_{fill} method to determining a bandwidth-constrained placement of data objects in a network of cooperating caches. For example, the Doubling Epoch method may be inserted into the Fixed-t_{fill} method as depicted in FIG. 5 at insertion point C, referenced by numeral 424.

As depicted in box 702, the Doubling Epoch method may determine if a change has occurred in the caches or the set of data objects. In an embodiment, a change may include, but is not limited to: an object update, a demand placement, introduction of a new object, a change in the access probability of an object and/or all of the data objects are placed. If no change is identified, then the method may increase the fill-time, as shown in box 706. For example, the fill-time may be doubled. The method may start again at or about insertion point B, and run again with the lengthen fill-time. In an embodiment, at least after the first iteration, the method may run the InitFill method to ensure that objects placed during previous iterations are accounted for. If a change is identified, the method may reset the fill-time to an initial value and start again.

An implementation of the Doubling Epoch method for bandwidth-constrained placement may be described by:

Input: A hierarchy H, a set of objsize sized objects ψ, and probabilities of access p(i, α) of objects iεψ at iε machines (H), and an initial placement P₀.

(i) Initialize fill-time to=δ_{fill}, where δ_{fill} is the minimum value such that for all iεmachines(H), bw(i)*δ_{fill}>objsize.

(ii) for(i=0, T₀=δ_{fill}; until done; i=i+1, Tᵢ=Tᵢ₋₁*2

Run Initfill method fill-time=Tᵢ, with the current placement resulting from the previous run.

(iii) Goto (i)

In the description above, “until done” means that the loop iteratively executes runs of Initfill method until such time that a change occurs, as previously described.

The Initfill and Doubling Epoch methods may be combined to enable dealing with changes that may occur during placing of a set of data objects. Whenever a change occurs, the system may begin a new placement with the initial fill-time and with the updated situation as input. A determination of how large a change or a type of change that may reset the fill-time may be based on preference of a network administrator or the type of network. On one hand, if a change is large, resetting t_{fill}=1 and starting over may be appropriate. On the other hand, if a change is small, a less radical adjustment to the placement schedule may be in order. Various heuristics may be used to determine when to reset or reduce the fill-time. In an embodiment, the heuristics may include decision functions based on changes to the inputs that affect placement decisions in the methods described above. In another embodiment, the heuristics may include time-based or performance based metrics. In an embodiment, the fill-time may be reset to a small value if any change to the collection of objects, any demand read, any update to a cached object, or any change to probabilities of access occurs or if a subset or combination of these factors occurs. In another embodiment, the fill-time may be reduced by some factor (e.g., divided in half) if any change to the collection of objects, any demand read, any update to a cached object, any change to probabilities of access occurs, or if a subset or combination of these factors occurs. In yet another embodiment, the fill-time may be reset to a small value or reduced if a threshold number of changes to the collection of objects, a threshold number of demand reads, a threshold number of updates to cached objects, or a threshold number of changes to probabilities of access occur, or if a threshold value of a weighted combination of counts of these actions occur. In still another embodiment, the fill-time may be reset periodically. In another embodiment, the fill-time may be reset if the hit rates fall significantly. In another embodiment, the fill-time may be reset if updates rates rise significantly.

In an embodiment, a method of placing data objects in a plurality of distributed caches may be modified to account for differences in the size of various data objects. Such an embodiment may include a value-density heuristic, herein referred to as the VariPlace method. The VariPlace method includes a modification in the swapping phase of one of the previously described methods. In any of the previously described placement methods, the benefit (e.g., AssignedBenefit) may be replaced with a benefit density function (e.g., AssignBenefit/size). Similarly, the value of a missing data object may be replaced by a value density function (e.g., value/size).

In an embodiment, an incremental space-constrained method may be included. The incremental space constrained method may begin with a space-constrained placement method but add an initial placement P_i. The method may change the frequency of access by a cache i to a previously placed object in that cache to infinity. The method may then proceed using the updated frequencies. Such an embodiment may guarantee that initially placed objects remain placed.

Another embodiment may include a continuous bandwidth-constrained placement method. In such an embodiment, fill-time may be selected using a heuristic (e.g., fixed amount of time, proportional to the average update rate of objects or size of objects or both, dynamically chosen to optimize hit rate for a workload, etc.) The virtual size of each object may be set to be the object's size times the object's update rate. This virtual size is thus proportional to the “cost” of maintaining a replica of the specified object in a cache as that object is updated over time. The Fixed t_{fill} method may then be run using the virtual sizes and the selected fill-time. It is believed that the resulting placement may represent a good subset of objects to keep at each cache based on the access rates and the cost of maintaining updated versions of these objects.

Another embodiment may include a variable server distance. Such an embodiment may accommodate a rich network topology in which servers may be located near some caches and far from others. Likewise, servers may be located at different distances from caches, and/or servers may have difference performance properties. To realize this embodiment, for each server providing content to clients and caches, a new dummy cache may be created. The dummy cache may be located in the network topology at the same place as the server. The network hierarch may include each of these dummy caches in a virtual cluster hierarchy in the same manner as regular caches. The bandwidth of each dummy cache may be set to 0. The contents of each dummy cache may be initialized to include the objects served by the corresponding server. The InitFill method may be used to ensure that the objects provided by servers are placed at the dummy caches and that the cost of accessing data from these dummy caches matches the miss cost of fetching data from the servers.

Another embodiment may include a server distance model to determine a space-constrained placement. To realize this embodiment, for each server providing content to clients and caches, create a new dummy cache located in the network topology at the same place as the server. Each of these dummy caches may be included in the virtual cluster hierarchy in the same manner as a regular caches. The space of each dummy cache may be set to the total size of objects served. The contents of each dummy cache may be initialized to include the objects served by the corresponding server. The incremental space-constrained InitFill method may now be used to ensure that the objects provided by servers are placed at dummy caches and that the cost of accessing data from these dummy caches matches the miss cost of fetching data from the servers.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements may be substituted for those illustrated and described herein, parts and processes may be reversed, and certain features of the invention may be utilized independently, all as would be apparent to one skilled in the art after having the benefit of this description of the invention. Changes may be made in the embodiments described herein without departing from the spirit and scope of the invention as described in the following claims.

What is claimed:

1. A method of placing data objects in a plurality of distributed caches, comprising:
providing information regarding a plurality of data objects;
determining at least one bandwidth-constrained placement of at least one data object; and
providing at least one copy of at least one data object to at least one distributed cache based on at least one determined bandwidth-constrained placement.

2. The method of claim 1, wherein providing at least one copy of at least one data object to at least one distributed cache based on at least one determined bandwidth-constrained placement comprises providing two or more copies of data objects to at least one distributed cache in an order determined by at least one bandwidth-constrained placement.

3. The method of claim 1, wherein providing information regarding a plurality of data objects comprises providing an estimate of the size of at least one data object.

4. The method of claim 1, wherein providing information regarding a plurality of data objects comprises providing an estimate of the probability of receiving a request to access at least one data object.

5. The method of claim 1, wherein providing information regarding a plurality of data objects comprises providing a record of historical requests to access at least one data object.

6. The method of claim 1, wherein providing information regarding a plurality of data objects comprises providing a location of at least one data object.

7. The method of claim 1, wherein providing information regarding a plurality of data objects comprises providing information regarding a plurality of data objects accessible via a distributed network in communication with at least one of the caches.

8. The method of claim 1, wherein determining at least one bandwidth-constrained placement of at least one data object comprises determining a fill time, wherein the duration of the fill time is sufficient to allow at least one copy of at least one data object to be provided to at least one distributed cache based on available bandwidth of at least one distributed cache.

9. The method of claim 1, wherein determining at least one bandwidth-constrained placement of at least one data object comprises determining placeable objects from among the plurality of data objects based on the provided information.

10. The method of claim 1, further comprising providing topology information describing the distance between two or more of the distributed caches.

11. The method of claim 1, further comprising providing a hierarchical structure to describe relationships between the distributed caches.

12. The method of claim 1, wherein determining at least one bandwidth-constrained placement of at least one data object comprises determining a benefit of at least one data object of the plurality of data objects.

13. The method of claim 1, wherein information provided regarding the plurality of data objects comprises estimates of probability of access requests for one or more data objects, wherein determining at least one bandwidth-constrained placement of at least one data object comprises determining one or more data objects having the highest estimated probability of access requests for at least one distributed cache.

14. The method of claim 1, wherein information provided regarding the plurality of data objects comprises estimates of probability of access requests for one or more data objects and estimates of the size of one or more data objects, wherein determining at least one bandwidth-constrained placement of at least one data object comprises determining one or more data objects having the highest estimated probability of access requests for at least one distributed cache, wherein the total size of the one or more determined data objects is less than or equal a maximum amount of data that at least one cache can receive during a predetermined fill time.

15. The method of claim 1, wherein determining at least one bandwidth-constrained placement of at least one data object comprises determining at least one placement of at least one data object in at least one cache of the plurality of distributed caches based on an estimated size of at least one data object, available time to provide at least one data object to at least one cache, bandwidth available to provide at least one data object to at least one cache, and at least one estimate of the probability of a request to access at least one data object on at least one cache.

16. The method of claim 1, wherein determining at least one bandwidth-constrained placement of at least one data object comprises determining at least one primary copy of at least one data object in at least one cache of the plurality of distributed caches; and determining at least one secondary copy of at least one data object in at least one cache of the plurality of distributed caches.

17. The method of claim 1, wherein determining at least one bandwidth-constrained placement of at least one data object comprises determining at least two first placements of at least one data object, wherein at least two first placements are on different caches of the plurality of distributed caches; and determining at least one second placement of at least one data object based on two or more first placements of at least one data object.

18. The method of claim 1, wherein determining at least one bandwidth-constrained placement of at least one data object comprises determining at least one first placement of at least one data object; and determining at least one missing data object, wherein at least one missing data object is not present in at least one first placement.

19. The method of claim 18, wherein determining at least one bandwidth-constrained placement of at least one data object further comprises determining at least one value of at least one missing data object.

20. The method of claim 18, wherein determining at least one bandwidth-constrained placement of at least one data object further comprises determining at least one value of at least one missing data object; determining at least one benefit of at least one data object present in at least one first placement; and determining whether at least one value of at least one missing data object exceeds at least one benefit of at least one data object present in at least one first placement.

21. The method of claim 18, wherein at least one first placement comprises a primary copy and at least one secondary copy of at least one data object; and wherein determining at least one bandwidth-constrained placement of at least one data object further comprises:
determining at least one value of at least one missing data object;
determining at least one sum of values of missing data objects;
determining at least one benefit of at least one data object present in at least one first placement; and
determining whether at least one value of at least one missing data object exceeds at least one benefit of at least one secondary copy of at least one data object present in at least one first placement.

22. The method of claim 21, further comprising replacing at least one secondary copy of at least one data object in at least one first placement with at least one missing data object, if at least one value of at least one missing data object exceeds at least one benefit of at least one secondary copy of at least one data object.

23. The method of claim 18, wherein at least one first placement comprises a primary copy and at least one secondary copy of at least one data object; and wherein determining at least one bandwidth-constrained placement of at least one data object further comprises:
determining at least one value of at least one missing data object;
determining at least one sum of values of missing data objects;
determining at least one benefit of at least one data object present in at least one first placement; and
determining whether at least one value of at least one missing data object exceeds at least one reduced benefit of at least one secondary copy of at least one data object present in at least one first placement, wherein at least one reduced benefit of a secondary copy of a data object comprises a benefit of the secondary copy minus a sum of values of missing data objects.

24. The method of claim 23, further comprising replacing at least one secondary copy of at least one data object in at least one first placement with at least one missing data object, if at least one value of at least one missing data object exceeds at least one reduced benefit of at least one secondary copy of at least one data object.

25. The method of claim 1, wherein determining at least one bandwidth-constrained placement of at least one data object comprises:
providing a fill time; and
determining at least one first placement based on the fill time.

26. The method of claim 25, further comprising:
increasing the duration of the fill time; and
determining at least one second placement based on the increased fill time duration.

27. The method of claim 25, further comprising:
increasing the duration of the fill time; and
determining at least one second placement based on the increased fill time duration;
wherein providing at least one copy of at least one data object to at least one distributed cache comprises providing at least one copy of at least one data object to at least one distributed cache based on at least one additional placement.

28. The method of claim 25, further comprising:
increasing the duration of the fill time;
determining at least one second placement based on the increased fill time duration;
wherein providing at least one copy of at least one data object to at least one distributed cache comprises providing at least one copy of at least one data object to at least one distributed cache based on at least one additional placement; and
continuing to increase the duration of the fill time, determine at least one additional placement based on the increased fill time duration, and provide at least one copy of at least one data object to at least one distributed cache based on at least one additional placement until a predefined event occurs.

29. The method of claim 25, further comprising:
increasing the duration of the fill time;
determining at least one second placement based on the increased fill time duration;
wherein providing at least one copy of at least one data object to at least one distributed cache comprises providing at least one copy of at least one data object to at least one distributed cache based on at least one additional placement; and
continuing to increase the duration of the fill time, determine at least one additional placement based on the increased fill time duration, and provide at least one copy of at least one data object to at least one distributed cache based on at least one additional placement until at least one cache is filled.

30. The method of claim 25, further comprising:
increasing the duration of the fill time;
determining at least one additional placement based on the increased fill time duration;
providing at least one copy of at least one data object to at least one distributed cache based on at least one additional placement; and
continuing to increase the duration of the fill time, determine at least one additional placement based on the increased fill time duration, and provide at least one copy of at least one data object to at least one distributed cache based on at least one additional placement until a predetermined change occurs in at least one data object.

31. The method of claim 25, further comprising:
increasing the duration of the fill time;
determining at least one additional placement based on the increased fill time duration;
providing at least one copy of at least one data object to at least one distributed cache based on at least one additional placement; and
continuing to increase the duration of the fill time, determine at least one additional placement based on the increased fill time duration, and provide at least one copy of at least one data object to at least one distributed cache based on at least one additional placement until placement of data objects is complete.

32. The method of claim 1, wherein providing at least one copy of at least one data object to at least one distributed cache comprises sending a request to access at least one data object to a host server of at least one data object.

33. The method of claim 1, wherein providing at least one copy of at least one data object to at least one distributed cache comprises sending a signal comprising at least one copy of at least one data object to at least one distributed cache.

34. A method of placing data objects in at least one cache, comprising
providing information regarding a plurality of data objects accessible via a distributed network;
determining at least one bandwidth-constrained placement of at least one data object in a plurality of cooperative caches based on the provided information; and
replacing at least one data object in a cache with at least one data object not in the cache based on a bandwidth-constrained placement determination.

35. A method of determining at least one placement of at least one data object within a distributed network, comprising:
providing information regarding a plurality of data objects accessible via a distributed network, wherein the distributed network comprises a plurality of cooperating cache memories;
determining at least one first bandwidth-constrained placement of at least one data object in at least two cache memories of the cooperating cache memories; and
determining at least one second bandwidth-constrained placement of at least one data object in at least one cache memory of the cooperating cache memories based on two or more determined first placements.

36. The method of claim 35, further comprising continuing to determine bandwidth-constrained placements of at least one data object in at least one cache memory of the cooperating cache memories until at least one bandwidth-constrained placement for each of the cooperating cache memories is determined.

37. The method of claim 35, wherein the plurality of cooperating cache memories comprise a hierarchy of cache memories.

38. The method of claim 35, wherein the plurality of cooperating cache memories comprise a hierarchy of cache memories, and wherein at least one first bandwidth-constrained placement determined comprises a placement on at least one individual cache memory.

39. The method of claim 35, wherein the plurality of cooperating cache memories comprise a hierarchy of cache memories, wherein at least one first bandwidth-constrained placement determined comprises a placement on at least one individual cache memory, and wherein determining at least one second bandwidth-constrained placement comprises comparing two or more first bandwidth-constrained placements of two or more individual cache memories related by the hierarchy.

40. The method of claim 35, wherein determining at least one first bandwidth-constrained placement of at least one data object in a cache memory comprises determining a benefit of at least one data object in the cache memory.

41. The method of claim 35, wherein determining at least one second bandwidth-constrained placement of at least one data object in at least one cache memory comprises determining a benefit of at least one data object in two or more cache memories.

42. The method of claim 35, wherein at least one second bandwidth-constrained placement comprises at least two copies of at least one data object.

43. The method of claim 35, wherein at least one second bandwidth-constrained placement comprises at least two copies of at least one data object, wherein the method further comprises determining a primary copy of at least one data object.

44. The method of claim 35, wherein at least one second bandwidth-constrained placement comprises at least two copies of at least one data object, wherein the method further comprises determining a primary copy of at least one data object, wherein determining the primary copy of at least one data object comprises determining the copy having the highest benefit among at least two copies.

45. The method of claim 35, wherein at least one second bandwidth-constrained placement of at least one data object comprises at least two copies of at least one data object, wherein the method further comprises determining a primary copy of at least one data object, and determining benefits of at least two copies of at least one data object based on which copy is the primary copy.

46. The method of claim 35, further comprising determining at least one missing data object after determining at least one first bandwidth-constrained placement, wherein at least one missing data object comprises a data object not present in at least one bandwidth-constrained placement.

47. The method of claim 46, further comprising:
determining a value of at least one missing data object;
determining at least one benefit of at least one data object in at least one bandwidth-constrained placement; and
determining whether to substitute at least one missing data object for at least one data object in at least one bandwidth-constrained placement based on the value of at least one missing data object and at least one benefit of at least one data object.

48. The method of claim 47, wherein determining whether to substitute at least one missing data object for at least one data object in at least one bandwidth-constrained placement based on the value of at least one missing data object and at least one benefit of at least one data object comprises:
determining a primary copy of at least one data object in at least one bandwidth-constrained placement;
determining at least one secondary copy of at least one data object in at least one bandwidth-constrained placement; and
determining whether the value of at least one missing data object is at least as large as the benefit of at least one secondary copy of at least one data object minus a cumulative total of values of missing data objects.

49. The method of claim 47, wherein determining whether to substitute at least one missing data object for at least one data object in at least one bandwidth-constrained placement comprises comparing at least one benefit of at least one data object in at least one bandwidth-constrained placement and at least one value of at least one missing data object, and if at least one value of at least one missing data object is larger than at least one benefit of at least one data object in at least one bandwidth-constrained placement then substituting at least one missing data object for at least one data object in at least one bandwidth-constrained placement.

50. The method of claim 35, wherein the information regarding a plurality of data objects accessible via the distributed network comprises information regarding at least one missing data object, wherein the method further comprises:
determining a value density of at least one missing data object
determining at least one benefit density of at least one data object in at least one bandwidth-constrained placement; and
determining whether to substitute at least one missing data object for at least one data object in at least one bandwidth-constrained placement.

51. The method of claim 50, wherein determining whether to substitute at least one missing data object for at least one data object in at least one bandwidth-constrained placement comprises comparing a value density of at least one missing data object and at least one benefit density of at least one data object in at least one bandwidth-constrained placement, and if the value density exceeds at least one benefit density, then substituting the missing data object corresponding to the value density for a data object corresponding to at least one benefit density.

52. The method of claim 35, further comprising determining placeable data objects for at least one cache memory from the plurality of data objects accessible via the distributed network, wherein a placeable data object comprises a data object transferable to a cache memory in a determined time based on available bandwidth of the cache memory.

53. A method of determining at least one placement of at least one data object within a distributed network, comprising:
providing information regarding a plurality of data objects accessible via a distributed network, wherein the distributed network comprises a plurality of cooperating cache memories;
determining at least one benefit of placing at least one data object within at least one cache memory; and
determining placement of data objects within the plurality of cooperating cache memories based on at least one determined benefit.

54. A method of determining at least one placement of at least one data object within a distributed network, comprising:
providing information regarding a plurality of data objects accessible via a distributed network, wherein the distributed network comprises a plurality of cooperating cache memories;
determining at least one benefit of at least one data object in at least two cache memories;
determining a primary copy of at least one data object;
determining at least one secondary copy of at least one data object;
determining a value of at least one missing data object, wherein a missing data object comprises a data object that does not have a primary copy; and
determining at least one bandwidth-constrained placement, wherein determining at least one bandwidth-constrained placement comprises:
determining whether to replace at least one primary copy of at least one data object with at least one missing data object; and
determining whether to replace at least one secondary copy of at least one data object with at least one missing data object.

55. A method of determining at least one placement of at least one data object within a distributed network, comprising:
providing information regarding a plurality of data objects accessible via a distributed network, wherein the distributed network comprises a plurality of cooperating cache memories;
providing a fill time;
determining a placement of data objects within the plurality of cooperating cache memories based on the fill time;
providing at least one copy of at least one data object to at least one cache memory based on the determined placement;
increasing the duration of the fill time; and
continuing to determine placements of data objects, to provide at least one copy of at least one data object to at least one cache memory, and to increase the duration of the fill time until the occurrence of a predefined event.

56. A method of determining at least one placement of at least one data object within a distributed network, comprising:
providing information regarding a plurality of data objects accessible via a distributed network, wherein the distributed network comprises a plurality of cooperating cache memories, and wherein the plurality of cooperating cache memories comprise at least one copy of at least one data object accessible via the distributed network;
determining at least one bandwidth-constrained placement of data objects in at least one cache memory, wherein at least one bandwidth-constrained placement of data objects includes at least one copy of at least one data object already present in at least one cache memory;
determining at least one missing data object, wherein a missing data object comprises a data object that is not in at least one bandwidth-constrained placement of data objects; and
determining whether to replace at least one data object in at least one bandwidth-constrained placement with at least one missing data object, wherein at least one copy of at least one data object already present in at least one cache memory is inhibited from being replaced.

57. A method of determining at least one placement of at least one data object within a distributed network, comprising:
providing information regarding a plurality of data objects accessible via a distributed network, wherein the distributed network comprises a plurality of cooperating cache memories;
determining at least one benefit density of at least one data object; and
determining at least one bandwidth-constrained placement of data objects within the plurality of cooperating cache memories based on at least one determined benefit density.

58. A system for distributing copies of data objects to one or more cache memories, comprising:
at least two cooperating cache memories; and
at least one processor configured to determine at least one bandwidth-constrained placement of at least one data object on at least one cache memory based on information regarding at least one data object.

59. A carrier medium comprising program instructions, wherein the program instructions are computer-executable to implement a method of placing data objects in a plurality of distributed caches, comprising:
determining at least one bandwidth-constrained placement of at least one data object based on information provided regarding a plurality of data objects; and
providing at least one copy of at least one data object to at least one distributed cache based on at least one determined bandwidth-constrained placement.

60. A carrier medium comprising program instructions, wherein the program instructions are computer-executable to implement a method of placing data objects in at least one cache, comprising:
determining at least one bandwidth-constrained placement of at least one data object in a plurality of cooperative caches based on information provided regarding a plurality of data objects accessible via a distributed network; and
replacing at least one data object in a cache with at least one data object not in the cache based on a bandwidth-constrained placement determination.

61. A carrier medium comprising program instructions, wherein the program instructions are computer-executable to implement a method of determining at least one placement of at least one data object within a distributed network, comprising:
determining at least one first bandwidth-constrained placement of at least one data object in at least two cache memories of a plurality of cooperating cache memories based on information provided regarding a plurality of data objects accessible via a distributed network; and
determining at least one second bandwidth-constrained placement of at least one data object in at least one cache memory of the cooperating cache memories based on two or more determined first placements.

62. A carrier medium comprising program instructions, wherein the program instructions are computer-executable to implement a method of determining at least one placement of at least one data object within a distributed network, comprising:
determining at least one benefit of placing at least one data object within at least one cache memory based on information provided regarding a plurality of data objects accessible via a distributed network, wherein the distributed network comprises a plurality of cooperating cache memories; and
determining placement of data objects within the plurality of cooperating cache memories based on at least one determined benefit.

63. A carrier medium comprising program instructions, wherein the program instructions are computer-executable to implement a method of determining at least one placement of at least one data object within a distributed network, comprising:
determining at least one benefit of at least one data object in at least two cache memories based on information provided regarding a plurality of data objects accessible via a distributed network, wherein the distributed network comprises a plurality of cooperating cache memories;
determining a primary copy of at least one data object;
determining at least one secondary copy of at least one data object;
determining a value of at least one missing data object, wherein a missing data object comprises a data object that does not have a primary copy; and
determining at least one bandwidth-constrained placement, wherein determining at least one bandwidth-constrained placement comprises:
determining whether to replace at least one primary copy of at least one data object with at least one missing data object; and
determining whether to replace at least one secondary copy of at least one data object with at least one missing data object.

64. A carrier medium comprising program instructions, wherein the program instructions are computer-executable to implement a method of determining at least one placement of at least one data object within a distributed network, comprising:
determining a placement of data objects within a plurality of cooperating cache memories based on information provided regarding a plurality of data objects accessible via a distributed network, and a provided fill time;
providing at least one copy of at least one data object to at least one cache memory based on the determined placement;
increasing the duration of the fill time; and
continuing to determine placements of data objects, to provide at least one copy of at least one data object to at least one cache memory, and to increase the duration of the fill time until the occurrence of a predefined event.

65. A carrier medium comprising program instructions, wherein the program instructions are computer-executable to implement a method of determining at least one placement of at least one data object within a distributed network, comprising:
providing information regarding a plurality of data objects accessible via a distributed network, wherein the distributed network comprises a plurality of cooperating cache memories, and wherein the plurality of cooperating cache memories comprise at least one copy of at least one data object accessible via the distributed network;
determining at least one bandwidth-constrained placement of data objects in at least one cache memory based on information provided regarding a plurality of data objects accessible via a distributed network, wherein the distributed network comprises a plurality of cooperating cache memories, wherein at least one bandwidth-constrained placement of data objects includes at least one copy of at least one data object already present in at least one cache memory;
determining at least one missing data object, wherein a missing data object comprises a data object that is not in at least one bandwidth-constrained placement of data objects; and
determining whether to replace at least one data object in at least one bandwidth-constrained placement with at least one missing data object, wherein at least one copy of at least one data object already present in at least one cache memory is inhibited from being replaced.

66. A carrier medium comprising program instructions, wherein the program instructions are computer-executable to implement a method of determining at least one placement of at least one data object within a distributed network, comprising:
determining at least one benefit density of at least one data object based on information provided regarding a plurality of data objects accessible via a distributed network, wherein the distributed network comprises a plurality of cooperating cache memories; and
determining at least one bandwidth-constrained placement of data objects within the plurality of cooperating cache memories based on at least one determined benefit density.

67. A carrier medium comprising data objects selected by a method comprising:
determining at least one bandwidth-constrained placement of a plurality of data objects based on information provided regarding a plurality of data objects; and
providing copies of a plurality of data objects to at least one cache based on at least one determined bandwidth-constrained placement.

68. The carrier medium of claim 67, wherein at least one determined bandwidth-constrained placement comprises an order in which to provide copies of data objects.

69. A carrier medium comprising data objects selected by a method comprising:
determining at least one first bandwidth-constrained placement of at least one data object in at least two cache memories of a plurality of cooperating cache memories based on information provided regarding a plurality of data objects accessible via a distributed network;
determining at least one second bandwidth-constrained placement of at least one data object in at least one cache memory of the cooperating cache memories based on two or more determined first placements; and
selecting data objects based on at least one second bandwidth-constrained placement.

70. A carrier medium comprising data objects selected by a method comprising:
determining at least one benefit of placing at least one data object within at least one cache memory based on information provided regarding a plurality of data objects accessible via a distributed network, wherein the distributed network comprises a plurality of cooperating cache memories; and
determining placement of data objects within the plurality of cooperating cache memories based on at least one determined benefit; and
selecting data objects based on the determined placement.

71. A carrier medium comprising data objects selected by a method comprising:
determining at least one benefit of at least one data object in at least two cache memories based on information provided regarding a plurality of data objects accessible via a distributed network, wherein the distributed network comprises a plurality of cooperating cache memories;
determining a primary copy of at least one data object;
determining at least one secondary copy of at least one data object;
determining a value of at least one missing data object, wherein a missing data object comprises a data object that does not have a primary copy;
determining at least one bandwidth-constrained placement, wherein determining at least one bandwidth-constrained placement comprises:
determining whether to replace at least one primary copy of at least one data object with at least one missing data object; and
determining whether to replace at least one secondary copy of at least one data object with at least one missing data object; and
selecting data objects based on at least one determined bandwidth-constrained placement.

72. A carrier medium comprising data objects selected by a method comprising:
providing information regarding a plurality of data objects accessible via a distributed network, wherein the distributed network comprises a plurality of cooperating cache memories, and wherein the plurality of cooperating cache memories comprise at least one copy of at least one data object accessible via the distributed network;
determining at least one bandwidth-constrained placement of data objects in at least one cache memory based on information provided regarding a plurality of data objects accessible via a distributed network, wherein the distributed network comprises a plurality of cooperating cache memories, wherein at least one bandwidth-constrained placement of data objects includes at least one copy of at least one data object already present in at least one cache memory;
determining at least one missing data object, wherein a missing data object comprises a data object that is not in at least one bandwidth-constrained placement of data objects;
determining whether to replace at least one data object in at least one bandwidth-constrained placement with at least one missing data object, wherein at least one copy of at least one data object already present in at least one cache memory is inhibited from being replaced; and
selecting data objects based on at least one determined bandwidth-constrained placement.

73. A carrier medium comprising data objects selected by a method comprising:
determining at least one benefit density of at least one data object based on information provided regarding a plurality of data objects accessible via a distributed network, wherein the distributed network comprises a plurality of cooperating cache memories;
determining at least one bandwidth-constrained placement of data objects within the plurality of cooperating cache memories based on at least one determined benefit density; and
selecting data objects based on at least one determined bandwidth-constrained placement.
